(19) United States
(12) Patent Application Publication
(10) Pub. No.: US 2015/0357846 A1
(43) Pub. Date: Dec. 10, 2015

(54) ELECTROCHEMICAL CELL AND METHOD OF MANUFACTURE

(71) Applicant: ADVEN SOLUTIONS INC., Edmonton (CA)

(72) Inventors: Weixing Chen, Edmonton (CA); Xinwei Cui, Edmonton (CA)

(21) Appl. No.: 14/763,478

(22) PCT Filed: Jan. 24, 2014
(86) PCT No.: PCT/CA2014/050055

§ 371 Date: Jul. 24, 2015

Related U.S. Application Data
(60) Provisional application No. 61/817,101, filed on Apr. 29, 2013.
(60) Provisional application No. 61/756,247, filed on Jan. 24, 2013.

(51) Int. Cl. H02J 7/00

(52) U.S. Cl. CPC H02J 7/0042; H02J 7/007

(57) ABSTRACT

A method of modifying an electrode for an electrochemical cell in which the electrode is in contact with an electrolyte comprising one or more salts containing metal ions and halogen ions connecting the electrode in a circuit comprising the electrode, the electrolyte, and an opposite electrode; and applying a charging current to the circuit charging the circuit to a first voltage sufficient to drive halogen ions into the electrode to modify the atomic structure of the electrode. An electrochemical cell comprising a first electrode, an electrolyte comprising one or more salts containing metal ions and halogen ions; and a second electrode, the second electrode containing halogen ions when the electrochemical cell is in a charged state.

### FIELD

Electrochemical cells, in particular fluoride ion batteries, lithium ion batteries.

### BACKGROUND

A lithium-ion battery (sometimes Li-ion battery or LIB) is a family of rechargeable battery types in which lithium ions move from the negative electrode to the positive electrode during discharge, and back when charging. Li-ion batteries use an intercalated lithium compound as the electrode material, compared to the metallic lithium used in the non-rechargeable lithium battery. One example of a lithium ion battery, made by or for Nokia, has an energy density of 250-730 W·h/L. All other things being equal, higher energy densities may be beneficial.

### SUMMARY

There is disclosed a method of modifying an electrode for an electrochemical cell in which the electrode is in contact with an electrolyte, the electrolyte comprising one or more salts containing metal ions and a halogen, the method comprising connecting the electrode in a circuit comprising the electrode, the electrolyte, and an opposite electrode; and applying a charging current to the circuit charging the circuit to a first voltage sufficient to drive halogen ions into the electrode to modify the atomic structure of the electrode.

In various embodiments there may be one or more of: comprising allowing a discharging current from the circuit discharging the circuit to a second voltage low enough to allow halogen ions to be released from the electrode, and in which the steps of applying the charging current and allowing the discharging current are repeated; the second voltage is low enough to allow metal ions to enter the electrode; the circuit is held at the first voltage for a first period of time before allowing the discharging current; the circuit is held at the second voltage for a second period of time before applying the charging current; the halogen is present in the electrolyte as halogen ions at least during charging; before applying the charging current to the electrochemical cell the electrode is free of halogen; the electrode comprises graphitic carbon; the graphitic carbon comprises at least one of graphite, graphitic carbon particles of either micron- or nano-size, carbon nanotubes (CNTs), carbon nanotube arrays (CNTAs), graphene, and graphene nanoribbons (GNRs); the carbon is modified by being attached with functional groups or being N-doped; the functional groups comprise one or more of —COOH, —NH₂, —F, —Cl, —Br, and —I; the electrode comprises non-graphitic carbon with a conductive additive; the electrode comprises graphitic or non-graphitic, functionalized or N-doped carbon mixed with another material; the other material is one or more of LiCoO₂, LiMnO₂, LiMn₂O₄, LiFePO₄, Si, MnOₓ, VOₓ, FeF₂, FeF₃ or S; the electrolyte comprises one or more of LiPF₆, LiF, LiAsF₆, LiBF₄, LiCF₃SO₃, LiN(SO₂CF₃)₂, LiCl, LiBr, LiI, CsF, MgF₂, BaF₂, VF₄, FeF₃, MoF₆, PdF₂, AgFe, AlF₃, PbF₄, BiF₃, LaF₃, YbF₃ and UF₅; the electrolyte comprises one or more of EC, DEC, DMC, DME, DMSO, EMC, 12-Crown-4 (C₈H₁₆O₄), 18-Crown-6 (C₁₂H₂₄O₆), tris(pentafluorophenyl) borane (TPFPB), tris(hexafluoroisopropyl)borate (THFIPB), 2-(2,4-Difluorophenyl)-4-fluoro-1,3,2-benzodioxaborole, 2-(3-Trifluoromethyl phenyl)-4-fluoro-1,3,2-benzodioxaborole, 2,5-Bis(trifluoromethyl)phenyl-4-fluoro-1,3,2-benzodioxaborole, 2-(4-Fluorophenyl)-tetrafluoro-1,3,2-benzodioxaborole, 2-(2,4-Difluorophenyl)-tetrafluoro-1,3,2-benzodioxaborole, 2-(Pentafluorophenyl)-tetrafluoro-1,3,2-benzodioxaborole; 2-(2-Trifluoromethyl phenyl)-tetrafluoro-1,3,2-benzodioxaborole, 2,5-Bis(trifluoromethyl phenyl)-tetrafluoro-1,3,2-benzodioxaborole, 2-Phenyl-4,4,5,5-tetrakis(trifluoromethyl)-1,3,2-dioxaborole, Difluorophenyl)-4,4,5,5-tetrakis(trifluoromethyl)-1,3,2-dioxaborole, 2-pentafluorophenyl-4,4,5,5-tetrakis(trisfluoromethyl)-1,3,2-dioxaborole, Bis(1,1,1,3,3,3-hexafluoroisopropyl)phenylboronate, Bis(1,1,1,3,3,3-hexafluoroisopropyl)-3,5-difluorophenylboronate, and Bis(1,1,1,3,3,3-hexafluoroisopropyl)pentafluorophenylboronate); the opposite electrode comprises one or more of lithium (Li), Sodium (Na), Magnesium (Mg), Aluminum (Al), Potassium (K), Calcium (Ca), iron (Fe), copper (Cu), Titanium (Ti), Manganese (Mn), silver (Ag), Cobalt (Co), Zinc (Zn), Nickel (Ni), their alloys, graphite, lithium fluoride, lithium titanium oxide (LiTiO) and Si; the electrode is a cathode and the charging current has a current density normalized by the weight of cathode material above 1 A/g; the electrode is a cathode and the charging current has a current density normalized by the weight of cathode material above 1 A/g and below 400 A/g; the method steps are carried out at a temperature in the range from −40 to 150° C.; the halogen comprises Fluorine; the halogen comprises Chlorine; the halogen comprises Bromine; the halogen comprises Iodine; the electrode comprises a pure metallic material; the electrode comprises one or more of Sodium (Na), Magnesium (Mg), Aluminum (Al), Potassium (K), Calcium (Ca), iron (Fe), copper (Cu), Titanium (Ti), Manganese (Mn), silver (Ag), Cobalt (Co), Zinc (Zn) and Nickel (Ni); the electrode comprises of a mixture of carbon, metallic materials and alloys of carbon and metallic materials; the electrode comprises a fluoride-containing substance; the fluoride containing substance is a Fe-fluoride; the electrode and the opposite electrode comprise carbon; the electrode and the opposite electrode comprise a metal; the metal ions comprise lithium; the metal ions comprise lithium and in which the halogen comprises Fluorine and in which the first voltage is between 2.0 V and 6.0 V; the metal ions comprise lithium and the halogen comprises Fluorine and in which the second voltage is between 1.0 V and 3.0 V; the metal ions comprise one or more of Sodium (Na), Magnesium (Mg), Aluminum (Al), Potassium (K), Calcium (Ca), iron (Fe), copper (Cu), Titanium (Ti), Manganese (Mn), silver (Ag), Cobalt (Co), Zinc (Zn) and Nickel (Ni).

There is also disclosed an electrochemical cell comprising a first electrode, an electrolyte comprising one or more salts containing a metal and a halogen; and a second electrode, the second electrode containing halogen ions when the electrochemical cell is in a charged state.

In various embodiments there may be one or more of: the second electrode comprises carbon; the carbon is modified by being attached to functional groups or being N-doped; the functional groups comprise COOH, NH₂ or F; the second electrode comprises non-graphitic carbon with a conductive additive; the electrolyte comprises lithium ions; the electrolyte comprises fluoride ions.

There is also disclosed a method of preparing an electrochemical cell comprising connecting the electrochemical cell comprising the first electrode, the electrolyte, and the second electrode; and applying a charging current to the circuit charging the circuit to a first voltage sufficient to drive halogen ions into the electrode to modify the atomic structure of the electrode.

In various embodiments there may be one or more of: allowing a discharging current from the circuit discharging the circuit to a second voltage low enough to allow halogen ions to be released from the second electrode, and in which the steps of applying the charging current and allowing the discharging current are repeated; the second voltage is low enough to allow metal ions to enter the second electrode; the electrochemical cell is held at the first voltage for a first period of time before allowing the discharging current; the electrochemical cell is held at the second voltage for a second period of time before applying the charging current.

### BRIEF DESCRIPTION OF THE DRAWINGS

Embodiments will now be described by way of example with reference to the figures, in which:

FIG. 1 An example of cell configuration and the electrochemical reactions in Induced Fluoride Ion-Carbon (iFIC) Batteries.

FIG. 2 An example of cell configuration and the electrochemical reactions in Induced Fluoride Ion-Metal (iFIM) Batteries.

FIG. 3 Inducing Process A for a thick (70 μm) CNT positive electrode electrochemically induced at 70° C.

FIG. 4 A comparison of X-ray photoelectron spectroscopy results of fluorine and lithium for the CNT electrodes after inducing by charging and discharging.

FIG. 5 A comparison of charge-discharge curves before and after Inducing Process A for a thick (70 μm) CNT positive electrode electrochemically induced at 70° C.

FIG. 6 Charge and discharge curves for a thick (70 μm) CNT positive electrode electrochemically induced at 70° C.

FIG. 7 Cyclicability of a thick (70 μm) CNT positive electrode electrochemically induced at 70° C.

FIG. 8 Charge and discharge curves for a thick (70 μm) CNT positive electrode at 22° C.

FIG. 9 Cyclicability of a thick (70 μm) CNT positive electrode at 22° C. and 70° C.

FIG. 10 The procedure of Inducing Process B.

FIG. 11 Cyclic voltammetry curves for a thin (˜3 μm) CNT positive electrode before and after Inducing Process B.

FIG. 12 Charge and discharge curves for a thin (˜3 μm) CNT positive electrode after Inducing Process B.

FIG. 13 Ragone Plot comparing the performance of a thin (˜3 μm) CNT positive electrode after Inducing Process B with those of other materials reported.

FIG. 14 Cyclicability of a thin (˜3 μm) CNT positive electrode after Inducing Process B.

FIG. 15 Charge and discharge curves at 70° C. for a thick (˜70 μm) CNT positive electrode after Inducing Process C.

### DESCRIPTION

There are disclosed secondary (rechargeable) electrochemical energy storage systems, such as fluoride ion batteries, lithium ion batteries, lithium batteries, fluoride-lithium ion batteries, lithium-fluoride ion batteries, fluoride ion capacitors, fluoride-lithium ion capacitors, and lithium-ion capacitors, in which fluoride ions and/or lithium (or other metal) ions move between the negative electrode and the positive electrode during charging and discharging. Although the principle is illustrated with an embodiment using lithium ions and fluoride ions, the principle is generally applicable to electrochemical cells with metal ions as cation and halogen ions as anion.

There is also disclosed a new set of reversible electrochemical reactions that enable the fluoride anion F⁻ to react with the positive electrodes (an induced fluorination process), and move back and forth between the two electrodes with the assistance of lithium (or other metal) ions. The electrochemical cells with multiple ion reactions exhibit high specific energy density, power density and excellent cyclicability. There is disclosed a set of novel reversible electrochemical reactions (involving fluoride anions, F⁻) on the positive electrodes made of non-fluoride-ion containing materials such as pure carbon materials, pure metallic materials, a mixture of the two, or the mixture with other active materials, after the embodied electrochemically-induced fluorination treatment in electrolytes containing one or more types of fluoride salts, for high performance rechargeable batteries.

The disclosed new set of electrochemical reactions that enable the fluoride anion F⁻ to react with the positive electrodes (an induced fluorination process) also provide a new way for fluorinating carbon materials with well-defined C to F atomic ratio. All the reported electrochemical fluorination (ECF) methods of which the inventors are aware (e.g., U.S. Pat. No. 2,519,983, 1950; U.S. Pat. No. 2,732,398, 1956; U.S. Pat. No. 6,391,182 B2, 2002) have to fluorinate the substrate comprising at least one carbon-bonded hydrogen which was replaced by fluorine atom during the processes. In addition, hydrogen fluoride was normally used in the electrolyte, which is highly toxic. This new method, however, drives fluoride ions or other halogen ions into the material to modify the atomic structure of the materials by intercalation. The substrate is not necessary to have carbon-bonded hydrogen atoms. The electrolyte is not necessary to have hydrogen fluoride.

The batteries are a new type in terms of their working principle. It involves in the fluorination of the positive electrode after the electrochemical cells comprising an anode, a cathode and an electrolyte are assembled.

We use the term Induced Fluoride Ion Batteries (iFIB) to differentiate the Fluoride Ion batteries that are fabricated using a positive electrode and a negative electrode with at least one electrode wholly or partially made of one or more materials containing fluoride-ions, immersed in the organic electrolytes that either contain or are free of lithium ions.

The iFIBs are assembled using a positive electrode and a negative electrode, both of which are made of non-fluoride-ion containing materials. The positive electrode can be made of pure carbon materials, pure metallic materials, a mixture of the two, or their mixture with other active materials.

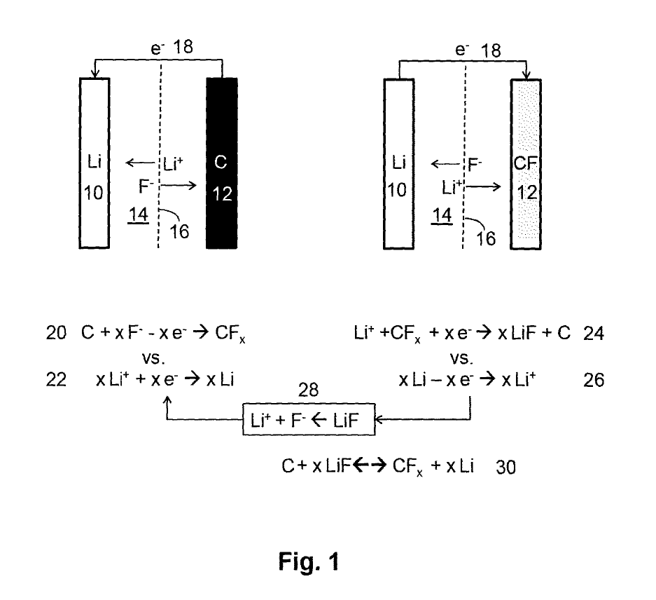

When the positive electrodes of the disclosed electrochemical cells are made of pure carbon materials or carbon containing materials, the iFIBs are termed as iFIC-batteries. The electrochemical reactions involved in a iFIC-batteries is illustrated in FIG. 1. Based on the new electrochemistry in FIG. 1, the theoretical specific energy of the iFIC-batteries can be increased up to 3574 Wh/kg_{(Li+C)}, which is higher than that of Li—O₂ batteries, 3505 Wh/kg_{(Li+O)}, and much higher than the conventional LiCoO₂/C batteries, 387 Wh/kg_{(LicoO2+C)}. As an example, an iFIC-batteries with a carbon nanotube (CNT) positive electrode has demonstrated a specific energy density of 2912 Wh/kg_{carbon} and 1941 Wh/kg_{(Li+C)}, and presented excellent cyclicability.

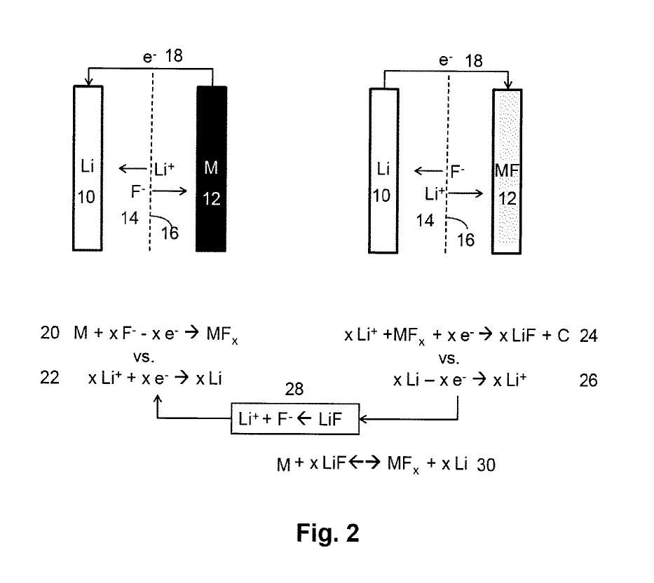

When the positive electrodes of the electrochemical cells are made of pure metals, alloys, or any materials containing pure metals or alloys, the iFIBs are termed as iFIM-batteries. The electrochemical reactions involved when the metal containing positive electrodes are used are given in FIG. 2. Any positive electrodes, containing either one or both of the above two types of materials, can be induced using the embodied electrochemically-induced fluorination treatment to achieve the reversible reactions described in FIG. 1 or FIG. 2.

The disclosed electrochemical cells are electrochemically induced by fluorinating the positive electrode made of fluoride-free materials after the electrochemical cells are assembled in order to bring up the reversible electrochemical reactions shown in FIG. 1 and FIG. 2. The F⁻ anions enter into the electrode to modify the atomic structure of the electrode, where modifying the atomic structure of the electrode may include creating defects and/or reacting with the atoms in the electrode.

Some components of the disclosed iFIBs can also be applied to Ms to improve their cycling performance, which include, but not limited to, a) the electrolytes used in the iFIBs, b) the inducing treatment used for the iFIBs.

The new battery cell configurations with the reversible electrochemical reactions proposed are illustrated in FIG. 1 for the positive electrodes made of pure carbon materials and in FIG. 2 for those made of pure metallic materials, respectively. FIG. 1 shows an electrochemical cell comprising a first electrode 10 (anode) and a second electrode 12 (pure carbon cathode) exposed to (in contact with) an electrolyte 14 comprising lithium ions and fluoride ions, separated by a separator 16, and connected outside in a circuit 18. As shown in the left part in FIG. 1, when applying a charging current to the circuit and charging the circuit to a first voltage, fluoride ions are driven into the electrode 12 to modify the atomic structure of the electrode 12, as indicated in the cathodic reaction 20. Accordingly, lithium ions are plated out or inserted into the electrode 10, as indicated in the anodic reaction 22. As shown in the right part in FIG. 1, when discharging, fluoride ions are driven out of the electrode 12, as indicated in the cathodic reaction 24, forming LiF solids. Simultaneously, lithium ions are released from the electrode 10, as indicated in the anodic reaction 26. The as-formed LiF solids can be electrochemically-assisted dissolved in a specific electrolyte, as indicated in the reaction 28. The total electrochemical reaction 30 is also shown in FIG. 1. FIG. 2 shows a second embodiment of an electrochemical cell comprising first electrode 10 (anode) and a second electrode 12 (pure metal cathode) exposed to an electrolyte 14 comprising lithium ions and fluoride ions, separated by a separator 16, and connected outside in a circuit 18. As shown in the left part in FIG. 2, when applying a charging current to the circuit and charging the circuit to a first voltage, fluoride ions are driven into the electrode 12 to modify the atomic structure of the electrode 12, as indicated in the cathodic reaction 20. Accordingly, lithium ions are plated out or inserted into the electrode 10, as indicated in the anodic reaction 22. As shown in the right part in FIG. 2, when discharging, fluoride ions are driven out of the electrode 12, as indicated in the cathodic reaction 24, forming LiF solids. Simultaneously, lithium ions are released from the electrode 10, as indicated in the anodic reaction 26. The as-formed LiF solids can be electrochemically-assisted dissolved in specific electrolyte, as indicated in the reaction 28. The total electrochemical reaction 30 is also shown in FIG. 2.

In order to achieve the suggested reversible electrochemical reactions described in FIG. 1 and FIG. 2, the positive electrodes are electrochemically induced by fluorinating the carbon or metallic materials before the battery cells are engaged for application service.

The inducing treatment enabling the electrochemical reactions described in FIG. 1 and FIG. 2 usually consists of one or multiple steps of electrochemically charging or charging-discharging the cells at specific temperatures for the same purpose of fluorinating the positive electrode after the electrochemical cells are assembled.

To maximize or to optimize the performance of the electrochemical cells, the electrochemical inducing treatments described in item 3 must be adjusted depending on 1) the type of material constituents in the positive electrodes, 2) the temperatures at which the activation process are performed, 3) the type of electrolytes in the cell, 4) the thickness of electrodes, 5) the range of reaction potential, depending on the type of electrolytes in the cell, and 6) the charging current density.

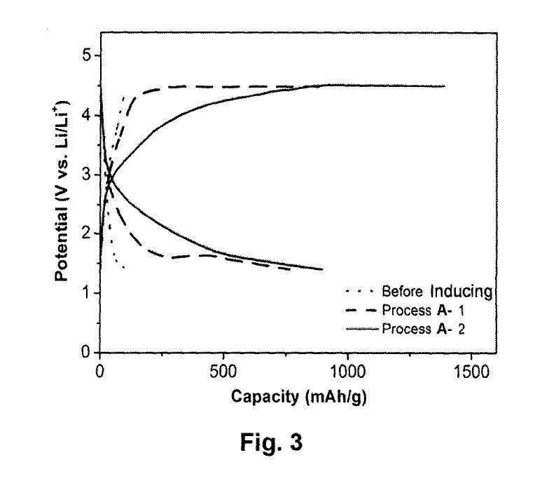

An example of the inducing treatment, denoted as Inducing Process A, is defined in FIG. 3, where the electrode was charged at a constant current density for two different periods of time (Inducing Processes A-1 and A-2). The charging at the constant current density over a long time has produced a potential plateau corresponding to an electrochemical reaction between the carbon/metallic materials and the fluoride anions that enables the occurrence of fluorination of the materials (carbon or metals or both) of the positive electrodes.

The increased discharging capacity after charging-inducing treatment has been proven to be caused by the fluorination of the non-fluoride materials in the positive electrodes through the reactions as defined in FIG. 1 and FIG. 2 for the carbon electrodes and the metal electrodes, respectively.

The fluorination of cathode materials during charge-inducing will form bonding between carbon and fluorine, which can be reversed during discharging. This is fundamentally different from the C—F bonding in Li—CFₓ batteries, for which the CFₓ is a pre-synthesized compound and the C—F bonding in CFₓ remains unchanged during charging and discharging and the charging and discharging are caused by the insertion and removal of Lithium ions.

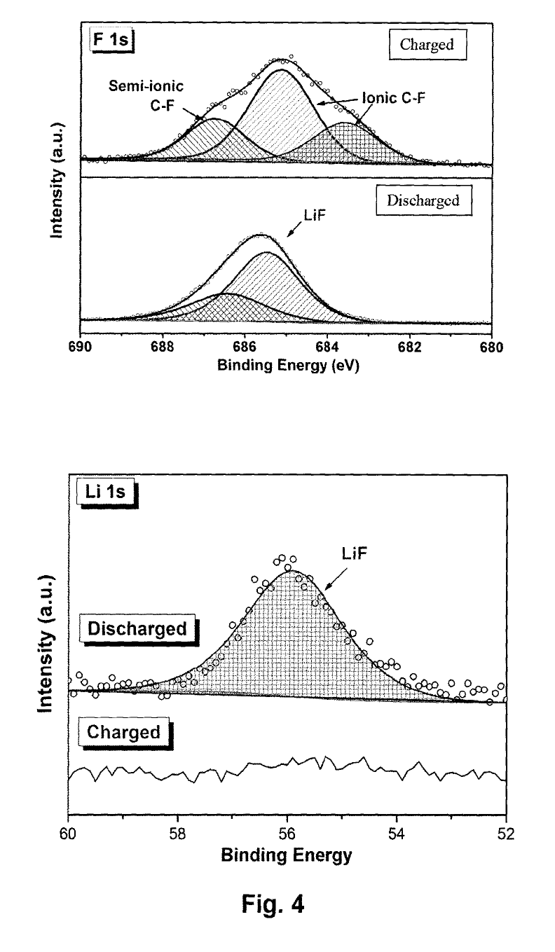

The fluorination of cathode materials during the charge-inducing can be clearly seen in FIG. 4, where a large amount of fluorine can be detected by X-ray photoelectron microscopy (XPS), but not lithium. During discharging, lithium can be detected, which combines with fluorine. This evidence proves the mechanism schematically shown in FIG. 1.

The charge inducing at a constant current density as shown in FIG. 3 may cause electrolyte decomposition if the plateau potential reaches to a high value. This can be prevented by various methods including reducing the crystal size of the active materials (nano-structuring the active materials) and the thickness of positive electrode, increasing the temperature at which inducing treatment is performed, and decreasing the charging current densities. The reaction potential range is between 2.0 V to 6.0 V depending on the electrolyte used. The inducing treatment temperature should be below the decomposition temperature of electrolyte (e.g., 40° C. to 260° C. for ethylene carbonate). The charging current density can be in the range from 0.005 A/g to 10 A/g.

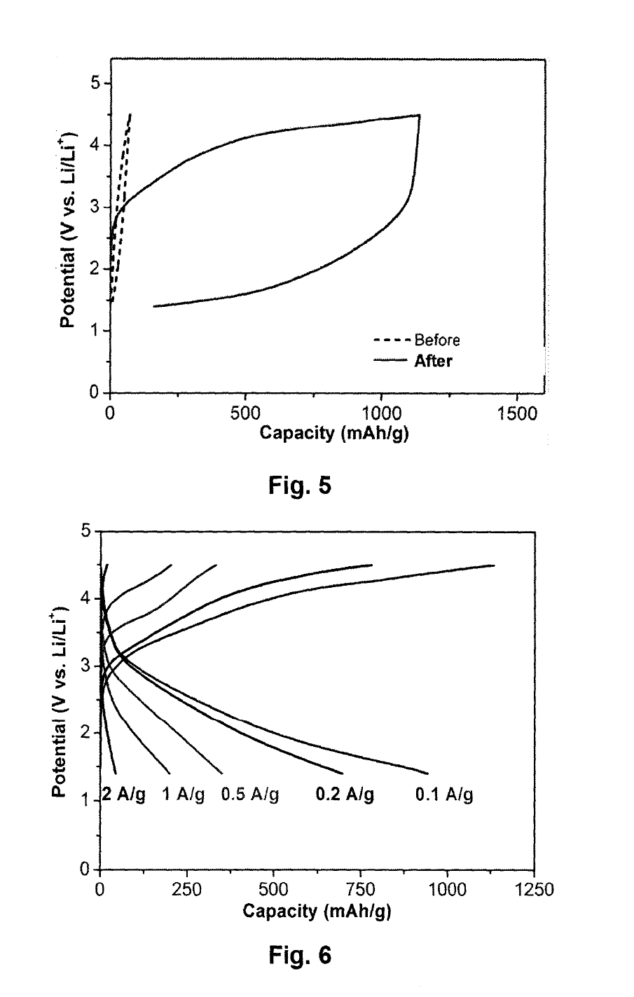

An example showing the performance of an electrochemical cell after the treatment using Inducing Process A is given in FIG. 5 to FIG. 9, which is detailed in Example II in the proceeding section.

When the temperature at which the inducing treatment is performed is reduced, for example, to the room temperature, multiple steps of charging-discharging may be necessary in order to achieve the fluorination of the materials in the positive electrodes. An illustration of such multiple steps of charging-discharging is given in FIG. 10. This multi-step inducing process is termed as Inducing Process B hereafter.

The charging-discharging steps in FIG. 10 may have to be performed at some extreme conditions that are usually not encountered during either testing or service operating of the batteries, especially the Lithium-ion batteries.

Details of parameters involved in Inducing Process B are provided below:

1. Starting voltage, V₁, can be a value in a range, but not limited to, between 1.0 V and 3.0 V.
2. Upper voltage, V₂, can be a value in a range, but not limited to, between 4.0 V and 6.0 V, depending on the electrolytes in the batteries.
3. Charging time, t₁, can be controlled through different current densities normalized by the weight of cathode material over a range from 0.01 A/g to 400 A/g, for example, at a current density of 150 A/g when activation is performed at room temperature. Charging at different current densities may lead to different scenarios of performance enhancement: 1) a simultaneous increase of specific energy density and power density, for example, when current density is controlled between 5 A/g and 400 A/g in the case of activation performed at room temperature; 2) an increase of specific energy density but decrease of specific power density, for example, when the current density falls between 0.01 A/g and 5 A/g. The charging density applied to the existing Lithium-ion batteries are normally in the range from 0.01 to 1 A/g. The charging at a current density in the range above 1 A/g will usually cause severe damage to their service life and therefore should be avoided for the existing Lithium-ion batteries.
4. Upper hold time, t₂, can last over a range from a few seconds to the magnitude of many minutes.
5. Discharging time, t₃, can be controlled through different current density normalized by the weight of electrode. In order to achieve an improved performance, the discharging time can be controlled to have the current density larger than, smaller than, or equal to the hold time following the charging stage.
6. Lower hold time, t₄, can be made over a range from a few seconds to the magnitude of many minutes, but is usually controlled to a period different from the hold time at upper voltage, t₂, in order to maximize the increase of performance.
7. Repeats of the charging and discharging cycles, N, in FIG. 10, should be normally in a range from 1 (for example, Inducing Process A) to over 1000 cycles, which should be determined based on whether an increment in performance can be obtained.
8. The electrochemical inducing treatment can be significantly shortened at higher temperatures. To process thick (20-100 μm) electrodes with the loadings of the carbon materials in the range of (1-10 mg/cm²), increasing the processing temperature in the range of 20° C. to 150° C. is also a necessary step. Also see Example III.

The fluoride or other halogen may be present in the electrolyte as part of a larger compound or ion which is dissociated to form fluoride or other halogen ions in the step of applying a charging current.

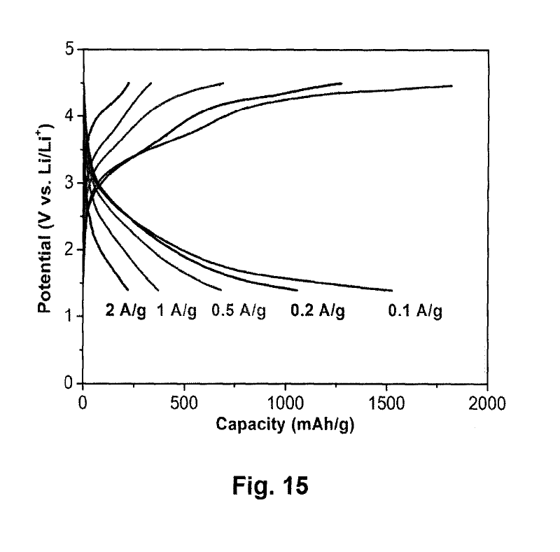

An electrochemical cell can also be activated by both Inducing Processes A and B to maximize the performance of electrochemical cells. The combination of Inducing Processes A and B are named as Inducing Process C and an example of Inducing Process C is given in Example IV, FIG. 15.

The above inducing processes can be applied to a battery or a setup that comprises an anode and a cathode separated by a separator immersed in organic electrolytes. The enhancement can be achieved regardless the weight, shape, and dimension of the carbon electrodes, although the degree of improvement can be different, depending on the type of cathode materials, besides the parameters used in electrochemical inducing treatment as described in paragraph [0032] and paragraph [0042].

When one or more than one Li-containing-fluoride salt(s), which can be either organic salt(s) or anhydrous metal fluoride salt(s), as to be defined later, are added into the electrolyte solvents, the anode can be made of, but not limited to, pure Li metal, Li powder, lithium fluoride, Li-alloys, graphite, lithium titanium oxide (LiTiO), Si, and their mixtures. These elements and/or compounds can be used either in their pure form or in their composite form or can be made by different methods and to achieve different dimensions or morphologies.

In the case of using pure Li metal or Li powders, a protective layer is suggested to deposit on the Li surface preventing the quick oxidation and reaction with moisture in the normal environment. The protective layer could be a metal layer, an organic layer, an organic/inorganic composite or multi-layer. Examples are a carbon layer, a lithium nitride layer (e.g., lithium phosphorus oxynidtride), a PEO-based polymer, a siloxane-based polymer, etc.

A protective layer of LiF can be spontaneously formed on the anode in the electrochemical cells. In the case of using lithium metal, lithium powders, lithium alloys as the anode, this side-reaction could inhibit the lithium dendrite formation and improve the safety of the batteries.

When one or more than one non-Li-containing-fluoride salt(s), which can be either organic salt(s) or anhydrous metal fluoride salt(s), as to be defined later, are added into electrolyte solvents, the anode can be made of, but not limited to, the carbon materials, or the pure metal(s) of the metal(s)-species contained in the fluoride salt(s) being added into the electrolyte solvents, such as, for example, Na, Mg, Al, K, Ca and transition metals and their mixtures. These elements and/or compounds can be used either in their pure form or in their composite form or can be made by different methods and to achieve different dimensions or morphologies. The pure metal(s) can be either a thin film, or powders sprayed on a conductive film, or present in a mixture containing other substances including other metals and graphite.

Those metals defined in the preceding paragraph may or may not be coated with a protective layer for the purpose of processing them in atmospheric environments depending on their stability in the atmospheric environments with controlled or non-controlled conditions.

The cathode can be made of any graphitic and non-graphitic carbon materials that are conventionally used entirely or partially to make the cathode in Li- and Li-ion-energy storage devices.

The graphitic carbons include but are not limited to graphite, graphitic carbon particles such as super P carbon, super C65, and super C45, of either micron- or nano-size, carbon nanotubes (CNTs), carbon nanotube arrays (CNTAs), graphene, graphene nanoribbons (GNRs). The non-graphitic carbons include but not limited to activated carbon, activated CNTs, activated graphene, activated GNRs, mesoporous carbon, mesocarbon microbeads (MCMB), or any other naturally existed or artificially synthesized carbon materials.

Any of the carbon materials identified in the preceding paragraph may in some embodiments be attached to functional groups, for example, carboxylic group (COOH) and amine group (—NH₂), or modified to achieve different chemical compositions (e.g., Nitrogen doped carbon materials), physical morphologies or dimensions by chemical, physical and chemical-physical approaches.

If non-graphitic carbon used, graphitic carbon or other conductive additives (e.g., metal/alloy particles) may need to be added to increase its conductivity.

Mixtures of graphitic and non-graphitic carbon materials with other cathode materials may also be used in some embodiments of the disclosed methods. The mixtures are, but not limited to, C—LiCoO₂, C—LiMnO₂, C—LiMn₂O₄, C—LiFePO₄, C—Si, C—MnOx, C—VOx, C—FeF₂, C—FeF₃ and C—S.

Adding functional groups (such as, but not limited to, —COOH, —NH₂) or adding different chemical compositions (e.g., N-doped) to the carbon materials may increase the final performance and the performance enhancement rate by the electrochemical activation process. The capacitance of the —COOH functionalized carbon nanotube electrodes can be improved from ˜100 F/g to ˜600 F/g using the electrochemical activation process but with half cycle numbers comparing with pristine carbon nanotube electrodes.

The cathode can also be made of pure metallic materials, such as Sodium (Na), Magnesium (Mg), Aluminum (Al), Potassium (K), Calcium (Ca), iron (Fe), copper (Cu), Titanium (Ti), Manganese (Mn), silver (Ag), Cobalt (Co), Zinc (Zn) or Nickel (Ni) or mixtures thereof.

The cathode can be made of a mixture of carbon, metallic materials and alloys of the carbon and metallic materials. Any positive electrode, containing either one or both of the above two materials, can be induced into a fluoride ion cell using the embodied inducing processes. In this way, the carbon- or metallic-containing materials will undergo the reversible fluorination and de-fluorination reactions; and hence, the total cell performance can be improved.

The cathode can be also made of fluoride-containing substances such as Fe-fluorides or any other substances, for which any of the inducing processes defined or the electrolytes identified in this disclosure can be applied to improve the performance of the electrochemical cells comprising a cathode made of the above mentioned substances.

The separators used in the battery can be those currently being used in Lithium-ion batteries. For high temperature applications, the separators that can sustain high temperatures should be used.

The electrolytes used in the battery or setup that can achieve high energy storage performance by embodiments of the disclosed electrochemical inducing processes can be the salts containing the element of F. The electrolyte can be either liquid-state or solid-state. The examples are, but not limited to, LiPF₆, LiAsF₆, LiBF₄, LiCF₃SO₃, LiN(SO₂CF₃)₂, any common anhydrous metal fluorides such as alkali or alkaline earth fluorides (e.g. LiF, CsF, MgF₂, BaF₂), transition metal fluorides (e.g. VF₄, FeF₃, MoF₆, PdF₂, AgF), main-group metal fluorides (e.g. AlF₃, PbF₄, BiF₃) and lanthanide or actinide fluorides (e.g. LaF₃, YbF₃, UF₅).

Solvents and additives may be included in the electrolyte and include EC (ethlylene carbonate), DEC (diethyl carbonate), DMC (dimethyl carbonate), DME (1,2-dimethoxyethane), DMSO (dimethyl sulfoxide), EMC (ethyl methyl carbonate), 12-Crown-4 (C₈H₁₆O₄) and 18-Crown-6 (C₁₂H₂₄O₆).

When the fluoride-containing salts are insoluble in the solvent, one or more than one of the following complex agents may be added to increase the solubility of the fluoride salts and the stability of electrolytes. These complex agents include, but not limited to, tris(pentafluorophenyl) borane (TPFPB), tris(hexafluoroisopropyl)borate (THFIPB), 2-(2,4-Difluorophenyl)-4-fluoro-1,3,2-benzodioxaborole; 2-(3-Trifluoromethyl phenyl)-4-fluoro-1,3,2-benzodioxaborole; 2,5-Bis(trifluoromethyl)phenyl-4-fluoro-1,3,2-benzodioxaborole; 2-(4-Fluorophenyl)-tetrafluoro-1,3,2-benzodioxaborole; 2-(2,4-Difluorophenyl)-tetrafluoro-1,3,2-benzodioxaborole; 2-(Pentafluorophenyl)-tetrafluoro-1,3,2-benzodioxaborole; 2-(2-Trifluoromethyl phenyl)-tetrafluoro-1,3,2-benzodioxaborole; 2,5-Bis(trifluoromethyl phenyl)-tetrafluoro-1,3,2-benzodioxaborole; 2-Phenyl-4,4,5,5-tetrakis(trifluoromethyl)-1,3,2-dioxaborole; Difluorophenyl)-4,4,5,5-tetrakis(trifluoromethyl)-1,3,2-dioxaborole; 2-pentafluorophenyl-4,4,5,5-tetrakis(trisfluoromethyl)-1,3,2-dioxaborole; Bis(1,1,1,3,3,3-hexafluoroisopropyl)phenylboronate; Bis(1,1,1,3,3,3-hexafluoroisopropyl)-3,5-difluorophenylboronate; Bis(1,1,1,3,3,3-hexafluoroisopropyl)pentafluorophenylboronate). Also see Example V.

The source of F⁻ anions for inducing the fluorination of positive electrodes may for example be the dissolved F⁻ anions in the electrolyte, or the released F⁻ anions from other anions (e.g., PF₆, BF₄, AsF₆) or other anion-complexing agents (e.g., TPFPB, THFIPB).

The range of temperature within which disclosed electrochemical cell can be operated can be from −40° C. to 120° C., depending on the type of electrolytes and separators used.

Other minor energy storage mechanisms may also exist in the systems, for example, a direct storage of lithium ions in carbon materials or metallic materials. Another example is the storage of lithium ions by functional groups, such as COOH, NH₂, etc.

### Example I

### Inducing Process a Applied to a Positive Electrode Made of CNT with an Electrode Thick of 70 μm

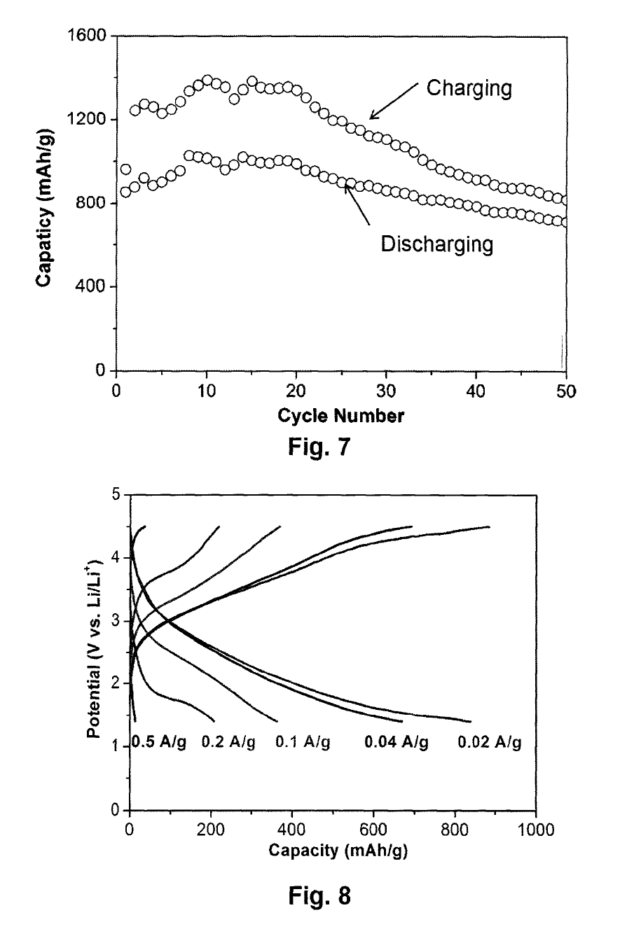

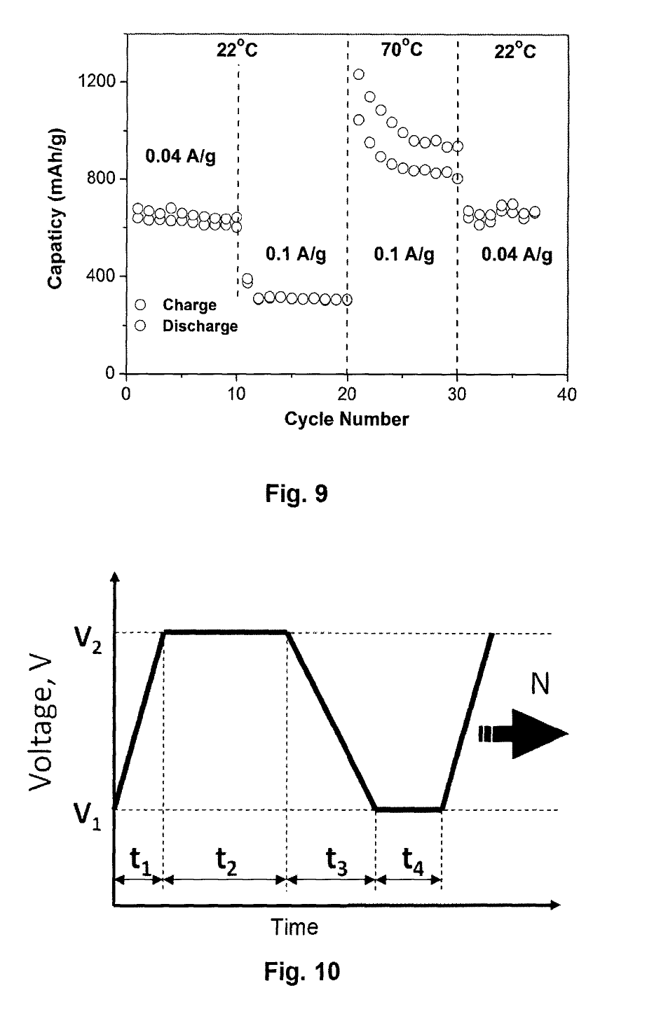

The CNT cathode shows a plateau at around 4.5 V vs. Li/Li⁺ at 70° C. when charged at the current density of 0.1 A/g, as shown in FIG. 3. Inducing Process A-1 was controlled to have a charging time of 30,000 s. The charging time in Inducing Process A-2 was controlled to be 50,000 s. After the activation through both the processes, the plateau disappeared and the carbon materials can be fluorinated and de-fluorinated reversibly, as shown in FIG. 5, FIG. 6 and FIG. 8. The CNT positive electrode also exhibited excellent cycle life, as shown in FIG. 7 and FIG. 9.

### Example II

### Inducing Process B Applied to a Thin (˜3 μm) CNT Positive Electrode

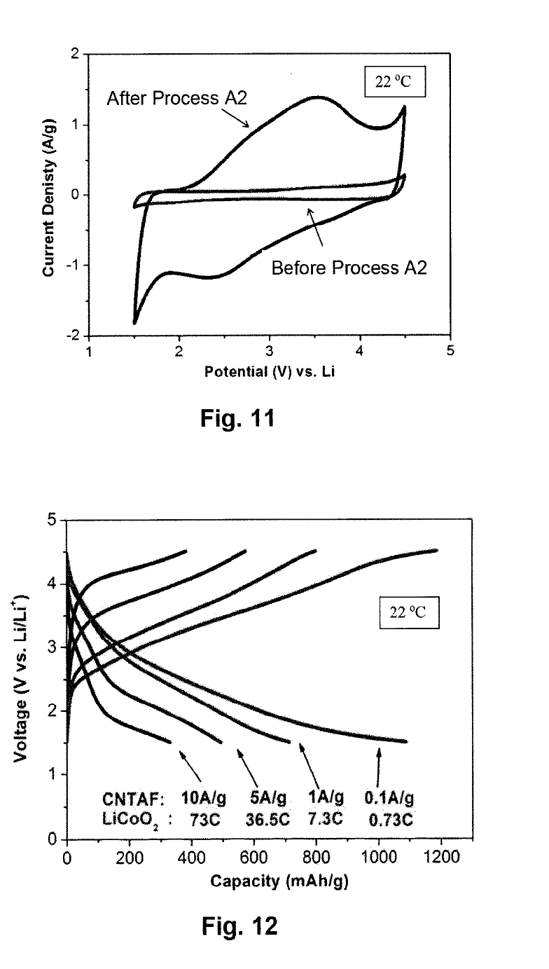

An example of performance enhancement achieved through fluorinated inducing treatment can be seen from a comparison of cyclic voltammetry curves of the same battery before and after the application of Inducing Process B, as shown in FIG. 11. In this example, the anode was a pure Li-film and the cathode was a sheet of as-fabricated carbon nanotube arrays in the electrolyte of 1M LiPF₆ in EC:DEC:DMC (1:1:1 volume ratio). In the electrochemical treatment, the battery was charged to 4.5 V at a current density of 200 A/g, held at 4.5 V for 50 min, discharged to 1.5 V at a current density of 200 A/g, and held at the lower voltage for 10 min. The number of inducing cycles was larger than 500 cycles. The above inducing treatment has yielded nearly 10 times of improvement in capacity as compared with the original value.

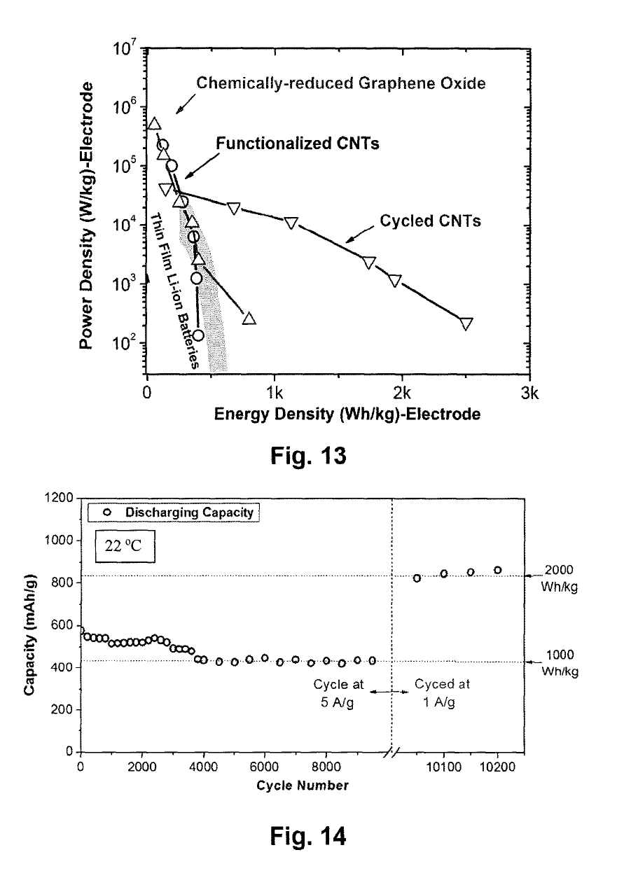

The charge-discharge curves shown in FIG. 12 and the Ragone Plot shown in FIG. 13 also reveal the improvement in performance by Inducing Process B. When the anode is Li metal, the novel reversible new electrochemical reaction brings up the capacity of carbon nanotubes over 1,000 mAh/g, corresponding to an energy density of 2,500 Wh/kg. The cycling performance is excellent, a capacity as high as 1000 mAh/g can sustain after 10,000 cycles, as shown in FIG. 14.

### Example III

### Inducing Process B Applied to a Thick CNT Positive Electrode at Two Different Temperatures

In this example, the increase in performance per inducing cycle is reduced with increasing inducing cycles when inducing a thick CNT electrode at 23° C. After 200 cycles of inducing treatment, the capacitance was slowly increased by only 10 F/g (from 190 F/g to 200 F/g) for additional 50 cycles (to the 250^{th} cycle). When the same battery pre-induced at 23° C. was heated up to 30° C. and induced using the inducing process shown in FIG. 10, the increase in capacitance for the 1^{st} 50 inducing cycle (to the 300^{th} cycle) at 30° C. was 50 F/g (from 200 F/g to 250 F/g).

### Example IV

### Inducing Process C, an Inducing Process Consisting of Inducing Processes B and A, Applied to a Thick (70 μm) CNT Positive Electrode

In this example, the thick (70 μm) CNT positive electrode was induced first at room temperature by Inducing Process B. The parameters used were: V₂=4.5 V, V₁=1.5 V, the current density from 10 to 200 A/g, t₂=30 min to 50 min, and t₁=10 to 30 min. The number of inducing cycles was around 200 cycles. After Inducing Process B, the CNT electrode was induced at 70° C. by Inducing Process A. The reaction potential plateau is around 4.45-4.48 V. The performance of the CNT electrodes after Inducing Process C (a combination of B and A) has been further improved, as shown in FIG. 15.

### Example V

One example of the electrolyte being used for inducing treatment is the solution containing 1 M LiF and 1M Tris-(pentafluorophenyl) borane (TPFPB) (being added to increase the solubility of LiF) in EC:DMC (1:2 volume ratio).

Another example of the electrolyte is the solution containing 0.2 M LiF, 0.2 M Tris-(pentafluorophenyl) borane (TPFPB) (being added to increase the solubility of LiI) and 0.8 M LiI in EC:DMC (1:1 volume ratio).

Although an electrochemical cell has been disclosed in which fluoride ions are driven by a charging voltage into the molecular structure of an electrode to thereby modify the electrode, due to the similarity of other halogen ions to the chloride ion, the inventors soundly predict that the disclosed process and apparatus will work with other halogen ions substituted for the fluoride ions, or any combination of halogen ions. In addition, on the same principle, although the electrolyte may comprise lithium, other metal ions may be used to replace the lithium. The halogen is present in the electrolyte as halogen ions at least during charging.

Immaterial changes may be made to what is disclosed without departing from what is claimed.

1. A method of modifying an electrode for an electrochemical cell in which the electrode is in contact with an electrolyte, the electrolyte comprising one or more salts containing metal ions and a halogen, the method comprising:
connecting the electrode in a circuit comprising the electrode, the electrolyte, and an opposite electrode; and
applying a charging current to the circuit charging the circuit to a first voltage sufficient to drive halogen ions into the electrode to modify the atomic structure of the electrode.

2. The method of claim 1 further comprising allowing a discharging current from the circuit discharging the circuit to a second voltage low enough to allow halogen ions to be released from the electrode, and in which the steps of applying the charging current and allowing the discharging current are repeated.

3. The method of claim 2 in which the second voltage is low enough to allow metal ions to enter the electrode.

4. The method of claim 2 in which the circuit is held at the first voltage for a first period of time before allowing the discharging current.

5. The method of claim 2 in which the circuit is held at the second voltage for a second period of time before applying the charging current.

6. The method of claim 1 in which the halogen is present in the electrolyte as halogen ions at least during charging.

7. The method of claim 1 in which before applying the charging current to the electrochemical cell the electrode is free of halogen.

8. The method of claim 1 in which the electrode comprises graphitic carbon.

9. The method of claim 8 in which the graphitic carbon comprises at least one of graphite, activated carbon, graphitic carbon particles of either micron- or nano-size, carbon nanotubes (CNTs), carbon nanotube arrays (CNTAs), graphene, and graphene nanoribbons (GNRs).

10. The method of claim 9 in which the carbon is modified by being attached with functional groups or being N-doped.

11. The method of claim 10 in which the functional groups comprise one or more of —COOH, —NH₂, —F, —Cl, —Br, and —I.

12-14. (canceled)

15. The method of claim 1 in which the electrolyte comprises one or more of LiPF₆, LiF, LiAsF₆, LiBF₄, LiCF₃SO₃, LiN(SO₂CF₃)₂, LiCl, LiBr, LiI, CsF, MgF₂, BaF₂, VF₄, FeF₃, MoF₆, PdF₂, AgFe, AlF₃, PbF₄, BiF₃, LaF₃, YbF₃ and UF₅.

16. The method of claim 1 in which the electrolyte comprises one or more of EC, DEC, DMC, DME, DMSO, EMC, 12-Crown-4 (C₈H₁₆O₄), 18-Crown-6 (C₁₂H₂₄O₆), tris(pentafluorophenyl) borane (TPFPB), tris(hexafluoroisopropyl)borate (THFIPB), 2-(2,4-Difluorophenyl)-4-fluoro-1,3,2-benzodioxaborole, 2-(3-Trifluoromethyl phenyl)-4-fluoro-1,3,2-benzodioxaborole, 2,5-Bis(trifluoromethyl)phenyl-4-fluoro-1,3,2-benzo dioxaborole, 2-(4-Fluorophenyl)-tetrafluoro-1,3,2-benzo dioxaborole, 2-(2,4-Difluorophenyl)-tetrafluoro-1,3,2-benzo dioxaborole, 2-(Pentafluorophenyl)-tetrafluoro-1,3,2-benzo dioxaborole; 2-(2-Trifluoromethyl phenyl)-tetrafluoro-1,3,2-benzo dioxaborole, 2,5-Bis(trifluoromethyl phenyl)-tetrafluoro-1,3,2-benzo dioxaborole, 2-Phenyl-4,4,5,5-tetrakis(trifluoromethyl)-1,3,2-dioxaborole, 2-(3,5-Difluorophenyl)-4,4,5,5-tetrakis(trifluoromethyl)-1,3,2-dioxaborole, 2-pentafluorophenyl-4,4,5,5-tetrakis(trisfluoromethyl)-1,3,2-dioxaborole, Bis(1,1,1,3,3,3-hexafluoroisopropyl)phenylboronate, Bis(1,1,1,3,3,3-hexafluoroisopropyl)-3,5-difluorophenylboronate, and Bis(1,1,1,3,3,3-hexafluoroisopropyl)pentafluorophenylboronate).

17. The method of claim 1 in which the opposite electrode comprises one or more of lithium (Li), Sodium (Na), Magnesium (Mg), Aluminum (Al), Potassium (K), Calcium (Ca), iron (Fe), copper (Cu), Titanium (Ti), Manganese (Mn), silver (Ag), Cobalt (Co), Zinc (Zn), Nickel (Ni), their alloys, carbon, graphite, lithium fluoride, lithium titanium oxide (LiTiO) and Si.

18-19. (canceled)

20. The method of claim 1 in which the method steps are carried out at a temperature in the range from 20 to 150° C.

21. The method of claim 1 in which the halogen comprises one or more of Fluorine, Chlorine, Bromine, Iodine, the complexing anion PF₆ and the complexing anion BF₄.

22-47. (canceled)

48. The method of claim 1 in which the charging current is held at the first voltage for a first period of time.

49. The method of claim 48 in which the electrode is a cathode and the charging current has a current density normalized by the weight of cathode material above 0.1 A/g and below 400 A/g.

50. The method of claim 48 in which the electrode is a cathode and the first voltage is held at least 10 minutes.

51. The method of claim 1 further comprising heating the electrochemical cell.
